(19) United States
(12) Patent Application Publication
(10) Pub. No.: US 2001/0014189 A1
(43) Pub. Date: Aug. 16, 2001

(54) Bearing assembly

(76) Inventor: Richard C. Lukezich, Troy, MI (US)

Correspondence Address: Ernest I. Gifford, P.O., Gifford, Krass, Groh, Sprinkle, Anderson, & Citkowski, P.C., 280 North Old Woodward, Suite 400, Birmingham, MI, 48009-5394, US

(21) Appl. No.: 09/748,675

(22) Filed: Dec. 22, 2000

Related U.S. Application Data
(63) Continuation-in-part of application No. 08/906,063, filed on Aug. 5, 1997, now abandoned.
Application No. 08/906,063 is a continuation of application No. 08/671,838, filed on Jun. 28, 1996, now abandoned.

(51) Int. Cl. F16C 33/02; F16C 35/00

(52) U.S. Cl. 384/416; 384/449; 384/276

(57) ABSTRACT

A bearing assembly for use with a wheel having an outer circumferential tire portion and an opening formed through a central portion. The bearing assembly includes a male member and a female member, each having a flange portion extending around its circumference at one end thereof and means for securing the members axially together at opposite ends thereof. Bearings are provided upon the male and female members and are sandwiched between the flanges and the wheel. The bearings are of a single piece construction and are formed to provide arcuate surfaces around the periphery of the bearing which provide the contact between the associated parts.

### RELATIONSHIP TO OTHER APPLICATIONS

The present application is a continuation-in-part application of U.S. Ser. No. 08/906,063 filed Aug. 5, 1997, which was a continuation application of Ser. No. 80/671,838 filed Jun. 28, 1996.

### BACKGROUND OF THE INVENTION

1. Field of the Invention

The present invention relates generally to wheel bearing and, more particularly, to a novel bearing assembly for rotatably supporting a shopping cart wheel and the like and which provides improved load carrying and impact absorbing capabilities.

2. Description of the Prior Art

Bearing assemblies are well known in the art for providing frictionless and load carrying support to wheeled structures and other assemblies. Virtually any type of structure in which one member is rotatably mounted relative to another requires some form of bearing support in order to operate.

Such bearing assemblies are particularly useful for providing load carrying support to the wheels of conventional shopping carts. Shopping cart wheel bearings are usually required to sustain heavy load forces which result from the carts being heavily loaded with merchandise and other goods combined with the fairly rough handling the carts typically have to undergo and the forces generated by impact of the cart with other objects. It is a commonplace occurrence for shoppers, upon entering a food market or other type store in which such carts are used, to test a number of different shopping carts before finding one that has a set of sufficiently functioning wheel and bearing assemblies.

U.S. Pat. No. 5,275,473, issued to Hicks, discloses a shopping cart wheel with polymeric bearing races for providing heavy-duty load carrying support and for resisting degradation resulting from high pressure washing systems. The wheel includes a central opening with a pair of oppositely facing bearing support cavities. A metallic inner sleeve extends through the opening and is received on opposite sides by respective pairs of male and female race members which sandwich therebetween first and second pluralities of ball bearings. The opposing male members each further include support cylinder portions which slidably engage over the metallic inner sleeve and abut one another at a central bisecting point of the wheel. The inner sleeve therefore provides most of the linear support and stress relieving capabilities to the bearing assembly.

While providing an improved bearing assembly as compared to previous steel race and ball-bearing type structures, the Hicks bearing device still relies largely upon the inner metal sleeve for providing the load bearing and load absorbing capabilities. While steel is an ideal choice for a load carrying member, once the member has become deformed due to an excessive load application, the bearing assembly becomes permanently damaged and will subsequently cease to function properly. Concurrently, the steel inner sleeve does not possess the ability to bend to any significant degree and then to resiliently flex back to its original shape in response to high impact forces. Further, there is no disclosure in the Hicks patent of a bearing assembly which includes a bearing which can be inexpensively molded as a single piece.

U.S. Pat. No. 3,360,314, issued to Di Loreto, discloses a bearing assembly which includes a male and a female member joined together to form the race for bearing members but there is no disclosure in that patent of a bearing assembly which includes a single piece bearing member.

### SUMMARY OF THE PRESENT INVENTION

The present invention is a bearing assembly for use with a wheel, particularly the type mounted to the lower extremities of a shopping cart, which provides an inexpensively produced bearing member providing substantially frictionless rotation of the wheel and at the same time providing improved load carrying and impact resistance capabilities. The shopping cart wheel is of a conventional design and normally includes an outer tire portion and an opening which is formed through a central portion to receive an axle and bearing assemblies. In the present invention, the bearing assembly comprises a substantially cylindrical shaped male member having flange projecting around a circumference of the male member. A substantially cylindrical female member is provided with a flange projecting around a circumference of the female member. The female member and the male member are joined together axially and are provided with central openings to receive an axle for the wheel.

A bearing is positioned upon each of the male and female members adjacent the flanges and in circumferential grooves formed on each edge of the opening through the wheel so that the bearing members are sandwiched between the wheel and the flanges formed on the male and the female members. The flanges and the grooves form a bearing race which enables the bearing members to rotate freely relative to the wheel and the joined female and male members and thus the wheel to rotate on the axle. The assembly of the male and female members and the materials used produce the bearing assembly provide resilient load carrying and shock absorbing capability to the assembly.

In a preferred embodiment, the bearings are of a single piece construction and are formed of a glass impregnated Teflon material which is ring shaped and with ball shaped portions joined together to form the ring. This permits the axle and wheel to freely rotate relative to each other with only arcuate bearing surfaces of the bearings providing engagement between the wheel and the axle.

The bearings according to a further preferred embodiment are constructed of a plurality of bearing elements which, although they are not spherical, nevertheless are provided with arcuate surfaces which act as the bearing surfaces for the bearings.

In another preferred embodiment the bearings are in the form a torroidal shaped member constructed of Teflon or similar material.

### BRIEF DESCRIPTION OF THE DRAWINGS

Reference will now be made to the attached drawings, when read in combination with the following specification, wherein like reference numerals refer to like parts throughout the several views, and in which:

FIG. 1 is an exploded view of a wheel and bearing assembly according to the present invention;

FIG. 2 is a cross-sectional view of an assembled wheel and bearing assembly of the present invention;

FIG. 3 is a fragmentary elevational view of a portion of the bearing shown in FIGS. 1 and 2;

FIG. 4 is a cross-sectional view of the bearing of the present invention taken substantially on line 4-4 of FIG. 3;

FIG. 5 is an elevational view of another preferred bearing of the present invention;

FIG. 6 is a cross-sectional view of a bearing of the present invention taken substantially on line 6-6 of FIG. 5;

FIG. 7 is an elevational view of yet another preferred bearing of the present invention;

FIG. 8 is a fragmentary elevational view of the bearing of FIG. 7 mounted in place; and

FIG. 9 is a cross-sectional view of a bearing of the present invention taken substantially on line 9-9 of FIG. 8.

### DETAILED DESCRIPTION OF THE PREFERRED EMBODIMENTS

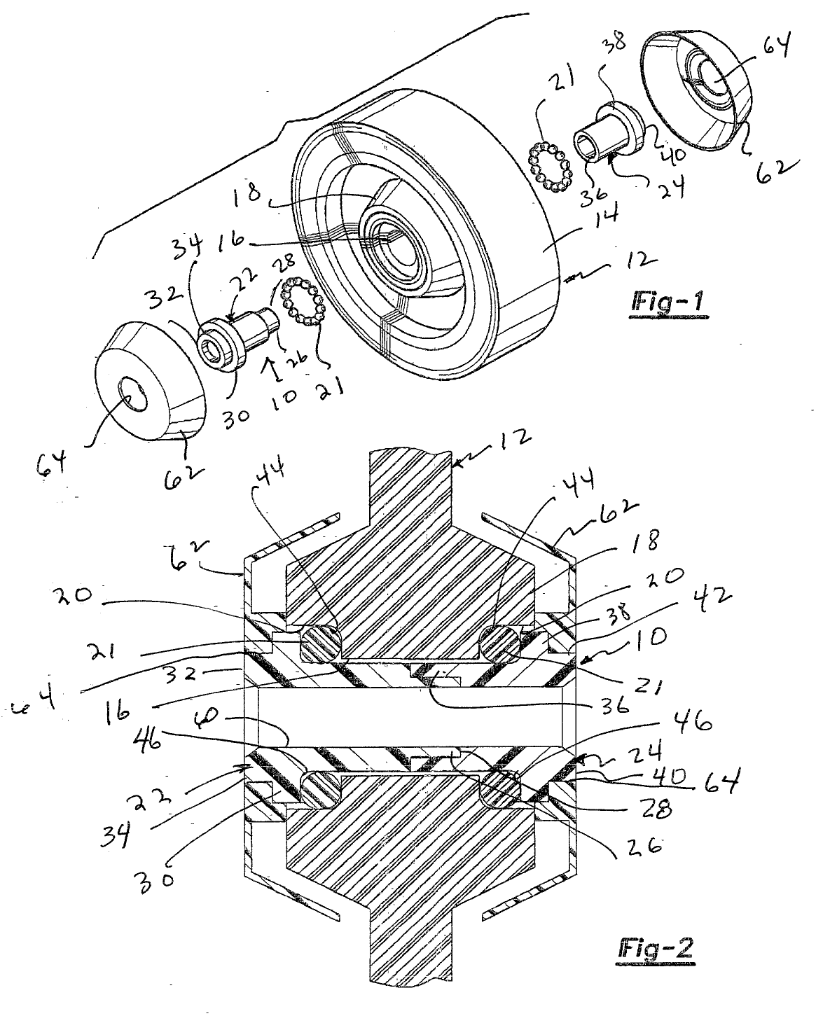

Referring now to FIGS. 1 and 2, and specifically to FIG. 1, a bearing assembly 10 is shown for use with a conventional wheel 12 according to the present invention. The wheel 12 is preferably of the type used for supporting a shopping cart and the like and is constructed of a durable polymer or metal material having an outer circumferential tire portion 14 and a through opening 16 which is formed through a central hub portion 18. The tire portion 14 is preferably constructed of a rubber or polymer material and the through opening 16 is provided with axially spaced grooves 20 (FIG. 2) to receive a pair of ring shaped bearings 21.

As is best shown by reference to FIGS. 1 and 2, the bearing assembly 10 further comprises a male bearing half 22 and a female bearing half 24. The bearing halves 22 and 24 are inserted into the through opening 16 formed within the wheel 12 from opposite sides thereof and with the bearings 21 in place at each end of the halves 22 and 24 to engage together in a manner which will be subsequently described. The bearing halves 22 and 24 are preferably formed of a resilient and impact resistant polymer material and are preferably produced in an injection molding process to create pieces having a high degree of tolerance and fit as well as lubricity, resilience and memory. The bearing halves 22 and 24 may also be constructed of a nylon material, commercially known as Minlow and produced by Dupont.

Referring again to FIGS. 1 and 2, the male bearing half 22 is substantially cylindrical in form and includes a male portion 26 of reduced diameter formed at an inner end 28 and a radially outwardly extending flange 30 formed adjacent an outer end 32. A protruding edge portion 34 extends past the flange 30 in an axial direction and terminates at the outer end 32.

Still referring still to FIGS. 1 and 2, the female bearing half 24 is shown as being substantially cylindrical and as including a female end 36 adapted to receive the male portion 26 of the male bearing half 22 to join the halves 22 and 24 together as best seen in FIG. 2. The female bearing half 24 is provided with a radially outwardly formed flange 38 spaced from an outer end 40 of the female bearing half 24. A protruding edge portion 42 extends past the flange 38 in an axial direction and terminates at the outer end 40.

The bearings 21 are mounted on the bearing halves 22 and 24 and are captured in the grooves 20 formed in the wheel 12 and by the flanges 30 and 38. The grooves 20 are preferably formed with arcuate surfaces 44 and the flanges 30 and 38 are formed with arcuate surfaces 46 to reduce friction between the bearings 21, the wheel 12 and the bearing halves 22 and 24.

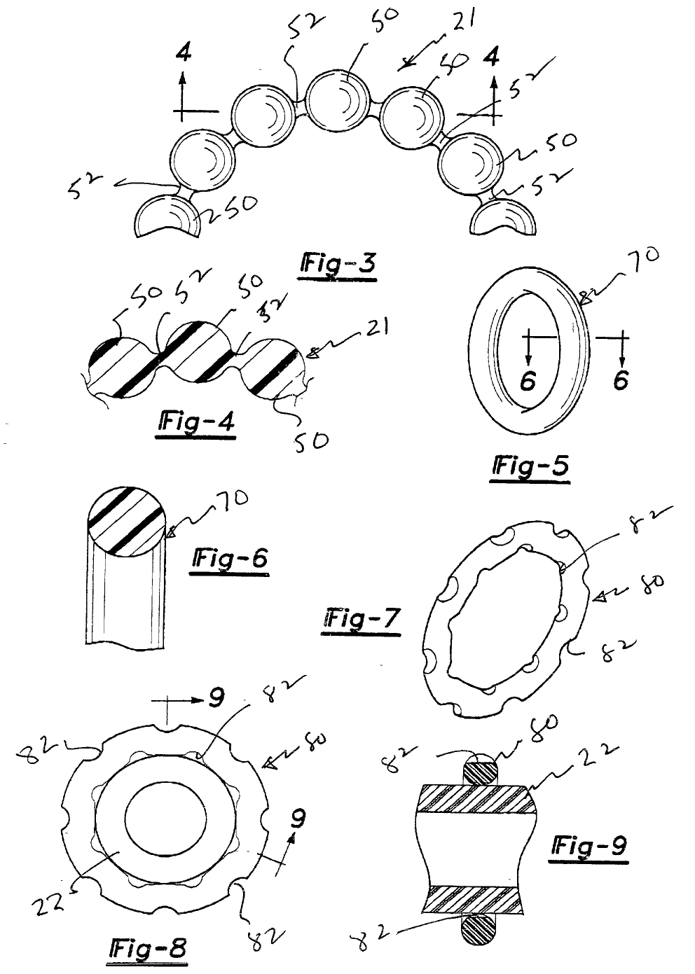

As can best be seen in FIGS. 3 and 4 each of the bearings 21 is formed of individual spherical members 50 joined together at 52 to form a ring. The bearing 21 is preferably molded as a single piece and is formed of a material such as Nylon. The bearing 21 may alternatively be constructed of a Teflon material which is glass impregnated to provide a hard ring-shaped member which is durable and provides substantially frictionless rotational contact. Only small portions of the arcuate surface of the spherical members 50 touch the wheel 12 and the bearing halves 22-24 as the wheel 12 is rotating.

As is best seen in FIG. 2, the bearings 21 are slidingly mounted to the bearing halves 22-24 prior to joining the halves 22 and 24 together within the through opening 16 in the wheel 12.

Still referring to FIG. 2, the joined halves 22-24 are provided with a through opening 60 adapted to receive an axle (not shown) for the wheel 12. The axle would be locked to the halves 22-24 so that in effect the halves 22-24 would be a part of the axle. A pair of caps 62 are provided for attaching to the wheel 12 over opposite ends of the bearing assembly 10 as is best shown in FIG. 2. Each of the caps 62 is formed in a generally saucer shape and includes an opening 64 in registry with the opening 60 for receiving the axle (not shown).

Upon the mounting of a shopping cart axle through the openings 50 and 52 and locking it to the bearing halves 22-24, the resiliency of the male and female bearing halves 22-24 enables the bearing assembly 10 to resiliently bend when faced with an extreme impact load and to then flex back to its original shape without damaging the parts of the bearing assembly 10 or the wheel 12. The two-piece construction which makes up the bearing assembly 10 contributes to the ability of the assembly 10 to absorb the loads and impact forces which would otherwise be transferred to the bearings 21 and the wheel 12.

Referring to FIGS. 5 and 6, a bearing 70 according to a second preferred embodiment is shown as comprising a torroidal shaped member adapted to fit in the race formed by the flanges 30, 38 and the grooves 20 of wheel 12 and bearing assembly 10. The bearings 70 are preferably formed of injection molded Teflon or Nylon. Again, only an arcuate surface of the bearing 70 engages the inner surface of the wheel 12 and the bearing halves 22, 24.

Referring to FIGS. 7, 8, and 9, a bearing 80, according to a third preferred embodiment, is shown as comprising a torroidal ring formed with portions removed on the inner and outer surface to minimize the contact between the bearings 80 and the wheel 12 and the bearing halves 22, 24. Again, the bearings 80 like bearings 21 and 70 provide arcuate surfaces which provide the contact between the associated parts. Also, the bearing 80, like the bearings 21 and 70, is preferably injection molded of Teflon or Nylon.

Therefore, the present invention teaches an improved bearing assembly for use with a wheel which provides substantially frictionless contact and which resiliently absorbs load and impact forces which are normally attendant during use. The bearing assembly capable of being quickly and efficiently produced and assembled within a wheel.

In each of the preferred embodiments of the bearings a one piece construction is provided and the bearing is formed so that an arcuate section of the bearing forms the contact between the bearing and the associated parts. The bearings are preferably molded and this provides an economically produced bearing which provides substantially frictionless bearing contact.

Having therefore described my invention, additional embodiments will become apparent to those skilled in the art to which it pertains without deviating from the scope of the appended claims.

I claim:

1. A bearing assembly for use with a wheel, the wheel having an outer tire portion, an opening which is formed through a central portion and a first groove and a second groove axially spaced and formed in said central portion communicating with said opening, said bearing assembly comprising:
a substantially cylindrical male member having a first flange extending around a circumference of said male member;
a substantially cylindrical female member having a second flange extending around a circumference of said female member;
a first bearing in said first groove and positioned upon said male member sandwiched between said first flange and said wheel;
a second bearing in said second groove and positioned upon said female member sandwiched between said second flange and said wheel;
engaging means for axially joining said male member to said female member through the central portion of the wheel; and
said bearings being of a single piece construction with arcuate surfaces which provide the contact between said joined male and female members and said wheel.

2. The bearing assembly for use with a wheel as described in claim 1, said joining means further comprising a reduced diameter sleeve portion extending axially from an inner end of said male member which is received in a pressure fit manner within an associated recess formed axially inwardly from an opposing inner end of said female member.

3. The bearing assembly for use with a wheel as described in claim 2, said bearing further comprising a plurality of spherical shaped members joined together to form a ring.

4. The bearing assembly for use with a wheel as described in claim 2, said first flange extending from said male member and said second flange extending from said female member in a position proximate to an outer end of each of said male member and said female member.

5. The bearing assembly for use with a wheel as described in claim 2, said bearing further comprising torroidal shaped member.

6. The bearing assembly for use with a wheel as described in claim 5, said bearing having an outer arcuate surface and sections being removed from said surface in the areas which would normally be in contact with said male or said female member and said wheel.

7. The bearing assembly for use with a wheel as described in claim 6, said bearing being formed by injection molding of a plastic material.

8. The bearing assembly for use with a wheel as described in claim 1, each of said bearing members further comprising a substantially frictionless and resilient nylon material in a ring shape.

9. The bearing assembly for use with a wheel as described in claim 1, each of said bearing members further comprising a glass impregnated Teflon ring.

10. The bearing assembly for use with a wheel as described in claim 1, each of said bearing member further comprising a plurality of balls which are joined together to form a ring.

11. The bearing assembly for use with a wheel as described in claim 1, further comprising said male and female members being constructed of a resilient and impact resistant polymer material.
